(19) United States
(12) Patent Application Publication
(10) Pub. No.: US 2007/0008516 A1
(43) Pub. Date: Jan. 11, 2007

(54) Light beam merging and guiding device

(76) Inventor: Rainer Uhl, Grafelfing (DE)

Correspondence Address: Peter N. Jansson;Jansson, Shupe & Munger, Ltd., Main Place, 245 Main Street, Racine, WI, 53403-1034, US

(21) Appl. No.: 11/521,001

(22) Filed: Sep. 14, 2006

Related U.S. Application Data
(63) Continuation-in-part of application No. PCT/EP04/02711, filed on Mar. 16, 2004.

(51) Int. Cl. G01J 1/00

(52) U.S. Cl. 356/123; 359/385

(57) ABSTRACT

A microscope having a device for merging different light beams, guiding them to a main beam outlet, and scrambling them in a way that a homogeneous intensity distribution is achieved there. When critical illumination is employed this carries over to a homogeneous illumination of the object plane of the microscope within the boundaries of a field of view determined by the boundaries of the main beam outlet. The device comprises a plurality of optical elements stacked in a row. The optical elements have light guiding properties and plane mating surfaces in a connection area between two adjacent optical elements, wherein the mating surfaces are inclined and serve as beam splitting surfaces.

### CROSS REFERENCE TO RELATED APPLICATION

This application is a continuation-in-part of International Application PCT/EP2004/002711, with an international filing date of Mar. 16, 2004, now abandoned. The content of International Application No. PCT/EP2004/002711 is incorporated herein by reference in its entirety.

### FIELD OF THE INVENTION

The invention refers to a light beam merging and guiding device used for the homogeneous illumination of the field of view of a microscope

### TECHNICAL BACKGROUND OF THE INVENTION

In modern microscopes, illumination of a specimen is subject to a multitude of different requirements. One important requirement is the possibility to combine light beams from more than one source and having different (e.g. spectral) characteristics for the illumination of a specimen under a microscope. For illumination with coherent radiation laser-line combiners are employed, which consist of a sequence of appropriate dichroic beam splitters (for example long-pass filters in suitable sequence). With their help several collimated laser-beams may be merged into one collimated beam.

Another requirement is to provide a special spatial beam profile (cross section) in the illumination path, providing a desired spatial or angular distribution of the beam in the specimen plane. Usually certain beam-stops are brought into the beam for this purpose, e.g. field-stops in a plane conjugate to the specimen plane, or aperture-stops or phase rings in a plane conjugate to the objective's pupil. The light “stopped by these stops” is wasted and leads to undesirable stray-light within the instrument.

### PRIOR ART

LED light sources are becoming increasingly popular in general lighting applications, and since they are now available in high power versions, they are becoming attractive for microscope illumination, too. Referring to FIG. 1, for combining light originating from differently colored monochromatic LED light sources into a desired beam of, for instance, rectangular beam profile in a plane conjugate to the specimen plane, a device 101 is known having a plurality of spaced dichroic beam splitters 105a, 105b, 105c which are arranged in a row, each having a suitable spectral characteristics matching the spectral range of the LED to be merged into the beam. However, due to the non-coherent, non-collimated nature of LED light sources, the maintenance of a required beam profile with, at the same time, maintained angular composition of the beam, requires relay-lenses 106 or other optical elements serving the same purpose to be placed in between the beam splitters 105a, 105b, 105c. Such an arrangement is quite costly and requires a lot of manual adjustments to avoid inconsistencies of the system. Moreover, it yields no spatially homogeneous illumination patterns.

Therefore, it is the object of the present invention to provide a light beam merging and guiding device which allows light from more than one source to contribute to a beam profile fulfilling special spatial requirements in a given plane, namely a desired cross-section and a high degree of homogeneity, and at the same time preserving a given angular distribution without the need for relay-optics.

### SUMMARY OF THE INVENTION

To solve this object, the invention provides a microscope illumination device for merging different light beams and guiding them to a main beam outlet window, which is imaged into a specimen plane, having dimensions which match a field of view to be illuminated and having a spatial intensity distribution which is made highly homogeneous by the device exhibiting not only light guiding, but also light scrambling properties, the device comprising a plurality of optical elements stacked in a row, the optical elements having plane mating surfaces in a connection area between two adjacent optical elements, wherein the mating surfaces are inclined and at least a fraction of those surface serves as beam splitting surface,

According to the invention, the device for merging different light beams at the same time serves to relay the central beam between the merging devices and to guide it to a main beam outlet of the device. By imaging the main beam outlet of the device into the specimen plane of the microscope, employing critical illumination (as opposed to the Köhler illumination usually used in microscopes), both the boundaries of the outlet and the even intensity distribution within the boundaries are preserved. Thus for illumination of an area to be inspected by a rectangular detector, the optical elements preferably have a rectangular cross-section.

The guiding of the rays within the device is achieved by the light guiding properties of the device which, at the same time, contains surfaces which are inclined and serve as beam splitting surfaces Thus, by incorporating the beam-splitting properties into an optical element, which at the same time possesses light-guiding properties and maintains a given angular beam profile, as suggested in the present invention, the need for discrete optical means between the beam merging points can be avoided. Besides light guiding properties the device also warrants beam-scrambling, leading to a homogeneous illumination pattern within its exit window boundaries.

Advantageously, the beam splitting surfaces function as dichroic beam splitters so that a combination of beams having different wavelength can be obtained.

Preferably, the filter characteristics of each beam splitting surface are different and the optical elements are arranged in a row according to their filter characteristics so that a specific light beam entering the device is reflected by the corresponding beam splitting surface, thereby being directed towards the main beam outlet of the device and passing through the beam splitting surfaces located ahead.

To obtain a maximum coupling efficiency and maximal compactness, the beam splitting surfaces are preferably arranged at an angle of 45° relative the longitudinal axis of the device.

By the preferred use of beam splitting surfaces functioning as long-pass filter or short-pass filter it is possible to limit the spectral composition of the resulting main beam.

To avoid any loss of uniformity of the beam and to guarantee its light guiding properties due to total internal reflection, the stack of optical elements advantageously comprises a uniform outline with polished surfaces.

According to a special embodiment of the present invention, the optical elements may also have a ring-shaped cross-section, and a second light guide may be enveloped by the ring-shaped optical elements. Thus, a second beam with a different cross-section may be brought into the same plane. This is helpful for e.g. TIRF- and phase contrast illumination. In these cases the main beam outlet window isn't imaged into the specimen plane, but into the objective's back focal plane.

According to another preferred embodiment, the optical elements have a cross-section of semi-circular arc shape.

A system for merging different light beams and guiding them to a main beam outlet further comprises a plurality of different light sources arranged to emit a beam in the direction of the corresponding beam splitting surfaces.

Preferably, the light sources are differently colored LED light sources, although the device is also applicable for light from other incoherent or coherent light sources. LED elements, however, can be turned on and off in microseconds or faster, they can be dimmed or modulated without costly electronics, and are therefore preferred.

Further features and advantages of the present invention will be apparent referring to the description and the accompanying drawings in which

### BRIEF DESCRIPTION OF THE DRAWINGS

FIG. 1 shows a side view of a light beam merging and guiding device known in the art;

FIG. 2 shows a perspective view of a first embodiment of the light beam merging and guiding device according to the invention;

FIG. 3 shows a perspective view of a second embodiment of the light beam merging and guiding device according to the invention;

FIG. 4 shows cross-sectional views of two versions of a third embodiment of the light beam merging and guiding device according to the invention;

FIG. 5 shows a cross-sectional view of a microscope incorporating the light beam merging and guiding device of FIG. 4;

FIG. 6 shows a cross-sectional view of a further embodiment of the light beam merging and guiding device according to the invention; and

FIG. 7 shows a side view of a further embodiment of the light beam merging and guiding device according to the invention.

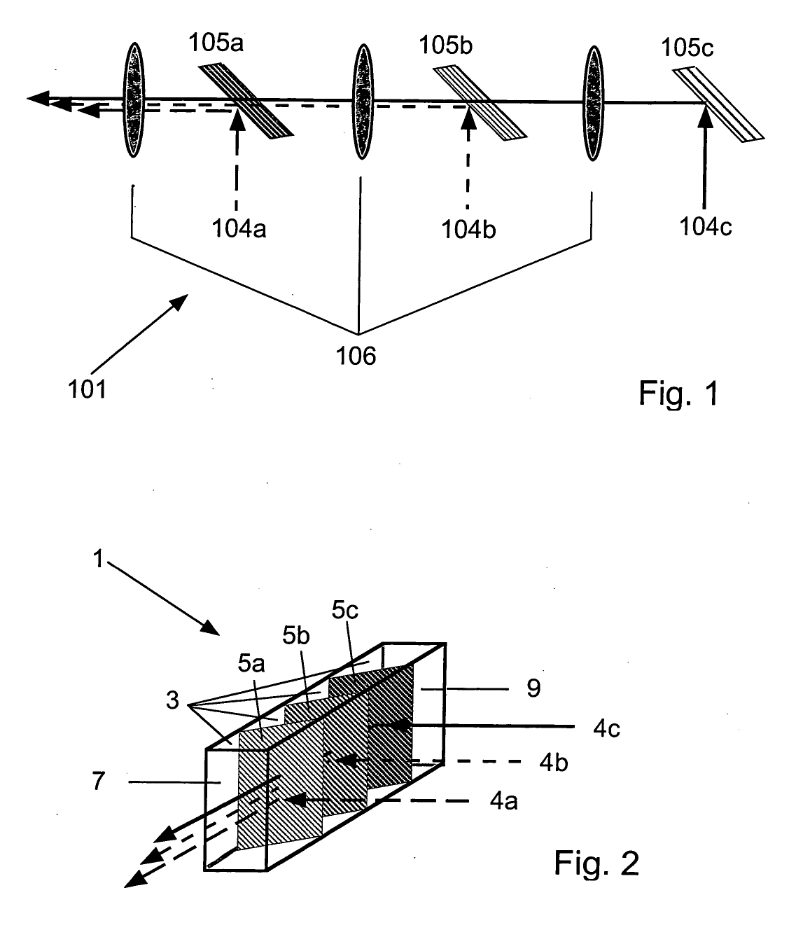

### DETAILED DESCRIPTION OF THE INVENTION

In FIG. 2, a first embodiment of the light beam merging and guiding device 1 according to the invention is shown. The device 1 comprises a plurality of optical elements 3, which are stacked in a row and have light guiding properties. Preferably, these optical elements 3 are formed of glass and comprise a uniform outline or cross-section (in this case rectangular). Thus, a given cross-section of a light beam passing the device 1 can be preserved over a distance. Further, this arrangement provides for scrambling of spatial inhomogenities and preserves the angular distribution of the beams, i.e. all beams are leaving the main beam outlet 7 of the device 1 with the angles of their entry.

In the connecting area between two adjacent optical elements 3 these elements comprise plane mating surfaces 5a, 5b, 5c, which are preferably stuck together by means of suitable glue or by other means known in the art. The plane mating surfaces 5a, 5b, 5c are inclined relative the longitudinal axis of the stack and, by being at least partially covered with suitable beam splitting coatings, can serve as beam splitting surfaces. In the embodiment shown in FIG. 2, the interior optical elements 3 are formed as parallelepipeds inclined at an angle of 45° relative the longitudinal axis of the stack. The beam splitting properties can be achieved by covering the surface with specific layers to provide the desired reflection/transmission characteristics. Such layers and structures are well known in the art.

In a preferred embodiment, each of the beam splitting surfaces 5a, 5b, 5c is formed as a long-pass filter, which reflects light beams of any wavelength below a predetermined boundary wavelength and allows beams of higher wavelengths to pass. In order to combine several light beams of different wavelengths into one main beam, it is desirable to arrange the beam splitting surfaces 5a, 5b, 5c according to their filter characteristics in a manner that a specific light beam entering the device 1 is reflected by the corresponding beam splitting surface 5a, 5b, 5c, thereby being directed towards the main beam outlet 7 of the device 1, and passes through the beam splitting surfaces 5a, 5b located ahead. Thus, it is either possible to arrange long-pass beam splitting surfaces 5a, 5b, 5c with cut-on wavelengths decreasing in direction towards the main beam outlet 7, or short-pass beam splitting surfaces with cut-on wavelengths increasing in direction towards the main beam outlet.

Furthermore, an additional light source (not shown) may be located near the end portion 9 of the light merging and guiding device 1 located opposite the main beam outlet 7. Light beams emitted by this light source should be able to pass through the whole merging and guiding device 1 to the main beam outlet 7. The invention allows to stack a plurality of optical elements 3 having n beam splitting surfaces and thus to combine (n+1) different light beam sources, since one light beam can be coupled in a straight fashion.

It is also possible to construct the device from trapezoids (not shown), in which case the light is coupled into the device from alternating directions.

In the device 1 of FIG. 2, beam 4c may, for instance, come from a non-coherent, monochromatic red light emitting diode (LED), beam 4b from a green LED and beam 4a from a blue LED. The long-pass splitting surface 5c fully reflects the entering red light beam, which passes through the other long-pass beam splitting surfaces 5a, 5b having a lower cut-on wavelength. Long-pass splitting surface 5b fully reflects the entering green light beam, which is directed towards the main beam outlet 7, and finally long-pass splitting surface 5a reflects the blue light beam so that the different light beams are merged into a main beam of desired cross-section and with constant angular distribution. Scrambling of the beam at the same time assures a spatially homogeneous illumination profile in the main beam outlet 7 of the light beam merging and guiding device 1 and hence in the specimen plane (not shown).

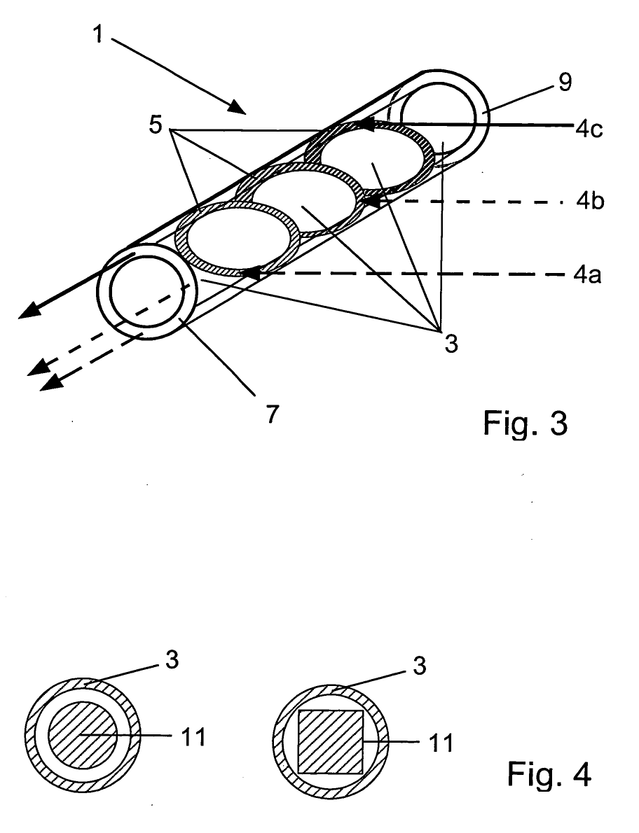

Referring to FIG. 3, a second embodiment of the light merging and guiding device 1 according to the invention is shown. As may be derived from the drawing, the device 1 comprises stacked optical elements 3 with ring-shaped cross-section, a geometry often required in the plane of an aperture stop, for instance for TIRF- or phase contrast illumination. A ring-shaped beam profile in this plane carries over to an angular illumination pattern, where only rays of a defined angle contribute to the illumination of the specimen.

To illuminate the ring-shaped beam splitting surfaces of the device 1, a “batwing” beam-profile of a LED chip is particularly suitable, i.e. the “Fourier-transformation” of a lens-system transforms the angular profile of a “batwing”-LED into a ring-shaped intensity pattern.

As may be seen from FIG. 4, the inside of the ring-shaped device may be used to bring a beam with a different cross-section into the same plane. This may happen with the help of classical optics or with the help of a second light guide 11, for instance a cylindrical one or a rectangular one.

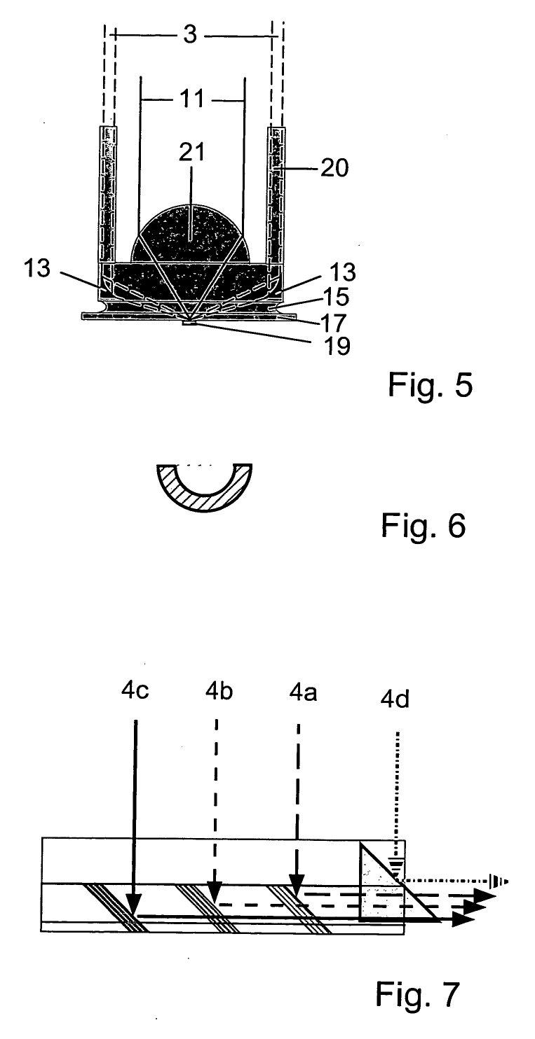

When used in the condenser for transmitted light illumination, the ring-shaped illumination profile may also be used for dark-field illumination or for TIRF-illumination from a side opposite to the objective lens used for inspecting a sample. A typical example for such an optical set-up is shown in FIG. 5. In this configuration, the ring-shaped main beam is directed via a ring-shaped concave mirror 13 through the immersion oil 15 and the cover slip 17 to the specimen 19. The second light guide 11 provides a second beam with, for instance, circular profile, which is brought to the specimen 19 via the condenser 21.

Under certain circumstances, for instance for TIRF illumination, it may be advantageous to use only one half of the light guiding tube, i.e. a cross-section of semi-circular arc shape as depicted in FIG. 6.

This facilitates the merging of another beam, as for instance used when combining TIRF-illumination, which requires a ring-shaped beam profile or a beam profile of semi-circular arc shape in a plane conjugate to the objective's pupil (for epi-illumination) or in the aperture plane of a condenser for transmitted light, with a regular widefield-illumination 4d, as shown in FIG. 7.

As opposed to lasers, LEDs usually exhibit a broad spectral range. This may be shaped by the use of suitable band-pass filters, which can be brought into the beam between a particular LED and the device for merging the light beams. Alternatively, by using a plurality of LEDs with overlapping spectral output, a spectral quasi-continuum may be created. When the output face-plate of such a device is used as entrance slit of a monochromator device as in DE 42 28 366, a system may be constructed which allows the free selection of a narrow wavelength-band from an extended spectral range.

LEDs can be gated or modulated with high frequency. All embodiments of the invention may preferably benefit from these features of LED-light sources.

Although a plurality of embodiments has been shown, the present invention is not limited to the described geometry, but can rather be applied in many further arrangements.

In particular, the inclination angle of the beam splitting surfaces may be varied, and both front end and rear end optical element can be formed as a longitudinally extending flexible light guide, for example as a glass fiber. Further, the light merging and guiding device according to the invention is also suitable for coherent light beams emitted by a laser light source.

While the principles of the invention have been shown and described in connection with specific embodiments, it is to be understood that such embodiments are by way of example and not limiting. Consequently, variations and modifications commensurate with the above teachings, and with the skill and knowledge of the relevant art, are within the scope of the present invention. The embodiments described herein are intended to illustrate best modes of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

What is claimed is:

1. A microscope illumination device for merging different light beams and guiding them to a main beam outlet window, which is imaged into a specimen plane, having dimensions which match a field of view to be illuminated and having a spatial intensity distribution which is made highly homogeneous by the device exhibiting not only light guiding, but also light scrambling properties, the device comprising a plurality of optical elements stacked in a row, the optical elements having plane mating surfaces in a connection area between two adjacent optical elements, wherein the mating surfaces are inclined and at least a fraction of those surfaces serve as beam splitting surfaces.

2. The device according to claim 1, wherein the beam splitting surfaces are adapted to function as dichroic beam splitters.

3. The device according to claim 1, wherein the beam splitting surfaces have filter characteristics which are different from one another.

4. The device according to claim 3, wherein the optical elements are arranged in a row according to their filter characteristics, so that a specific light beam entering the device is reflected by the corresponding beam splitting surface, thereby being directed towards the main beam outlet window of the device and passing through beam splitting surfaces located ahead.

5. The device according to claim 1, wherein the beam splitting surfaces are arranged at an angle of 45° relative to a longitudinal axis of the device.

6. The device according to claim 1, wherein the beam splitting surfaces function as a long-pass filter.

7. The device according to claim 1, wherein the beam splitting surfaces are adapted to function as a short-pass filter.

8. The device according to claim 1, wherein a stack of optical elements formed by said optical elements stacked in a row comprises a uniform outline.

9. The device according to claim 1, wherein at least a fraction of the optical elements have a rectangular cross-section.

10. The device according to claim 1, wherein at least a fraction of the optical elements have a ring-shaped cross-section.

11. The device according to claim 1, wherein at least a fraction of the optical elements have a cross-section of a semi-circular arc shape.

12. The device according to claim 10, wherein a second light guide or classical optical means resulting in a central beam profile is enveloped by the optical elements.

13. A system for merging different light beams and guiding them to a main beam outlet, comprising a device according to claim 1 and further comprising a plurality of different light sources arranged to emit a beam in a direction of corresponding beam splitting surfaces.

14. The system according to claim 13, wherein the light sources are differently colored LED light sources.

15. The system according to claim 13, wherein an additional light source is located near an end portion of the merging and guiding device located opposite the main beam outlet window, and wherein light beams emitted by this light source pass through the whole merging and guiding device.

16. The system according to claim 14, wherein suitable band-pass filters are arranged in a beam path between a particular LED and the device for merging the light beams.

17. The system according to claim 14, wherein all LEDs are adapted to be gated or modulated with high frequency.

18. The system according to claim 14, wherein the LEDs have an overlapping spectral output, so that the system may create a spectral quasi-continuum.

19. The system according to claim 18, wherein the main beam outlet is adapted to serve as a broadband illuminated entrance slit of a monochromator, to allow a free selection of a narrow wavelength-band.

20. A microscope comprising a system according to claim 13, wherein at least a fraction of the optical elements guiding a first light beam have a cross-section of one of a ring shape and a semi-circular arc shape, and wherein the optical elements envelop one of a second light guide and classical optical elements resulting in a second central light beam, the microscope further comprising a ring-shaped concave mirror to guide the first light beam to a specimen, and a condenser to guide the second central light beam to the specimen.
